(19) United States
(12) Patent Application Publication
(10) Pub. No.: US 2009/0157815 A1
(43) Pub. Date: Jun. 18, 2009

(54) MOBILE DEVICE FOR PROVIDING BLOG SERVICE AND METHOD FOR PROVIDING BLOG SERVICE USING THE SAME

(75) Inventors: Hyuk Namkoong, Suwon-si (KR); Sang-hyun Shin, Suwon-si (KR); Yong-jun Lim, Seoul (KR); Byeong-seob Ko, Suwon-si (KR); Seung-woo Shin, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/203,961

(22) Filed: Sep. 4, 2008

(30) Foreign Application Priority Data
Dec. 14, 2007 (KR) 2007-131079

(51) Int. Cl. G06F 15/16; G06F 17/00; G06F 17/30

(52) U.S. Cl. 709/204; 707/100; 726/1; 707/E17.044

(57) ABSTRACT

A mobile device for providing a blog service and a method and system for providing the blog service. The mobile device that operates as a blog providing server includes: a unit for obtaining raw data; a storage unit storing the raw data and blog information; and a blog editor generating/editing a blog page by using the raw data and the blog information.

### CROSS-REFERENCE TO RELATED APPLICATION

This application claims the benefit of Korean Patent Application No. 2007-131079, filed in the Korean Intellectual Property Office on Dec. 14, 2007, the disclosure of which is incorporated herein in its entirety by reference.

### BACKGROUND OF THE INVENTION

1. Field of the Invention

Aspects of the present invention relates to a service for providing a blog, and more particularly, to a method and apparatus for providing a blog service by using a mobile device.

2. Description of the Related Art

As the Internet has been developed, blogs are becoming popular. The term “blog” is a combination of the term “web” and “log”. Blogs are a representative type of one-person media. People freely upload columns, diaries, articles, and the like to a blog based on concerns of the people. In addition, people gather materials by reading or copying articles obtained by visiting a blog of another person.

In the past, a blog is mostly used through a blog service system over the Internet that is provided by a blog service provider, such as Google, flicker, and YouTube. Accordingly, an Internet accessible environment is required, so that a user generates a blog using the aforementioned commercial blog service system or visits a blog of the user or another user. The user can generate/edit the blog of the user within a range of diversity provided by the service provider. For example, since blog data generated/edited using the user's personal computer (PC) has to be uploaded to a blog server of the service provider, a user first accesses to the blog server through the Internet so as to see the user's blog.

In addition, diversity of services provided by the blog service provider is limited. For example, as shown in FIG. 1, the number of layouts of a blog page provided by the service provider is considerably limited. In addition, blog page data prepared by the user has to be encoded in a file format determined by the service provider, before being uploaded to the blog server. For example, YouTube requires a flash video (FLV) format as a video file format. Accordingly, in order to see videos stored in the blog server, a dedicated program to execute files with the required file format has to be installed. In addition, the blog service provider limits storage capacity for each user in the blog server.

### SUMMARY OF THE INVENTION

Aspects of the present invention provide a mobile service capable of providing a blog service so as to solve a problem in that a user can accesses a blog only in an Internet environment. The mobile device may thus operate as a blog server. Accordingly, the user can prepare a blog in real time using the mobile device. Whenever the user wants to see the blog, the user can see the blog. In addition, since the blog service is provided to a terminal of another user, the user can share the blog with another user and see the blog together with another user.

According to an aspect of the present invention, a mobile device that operates as a blog providing server is provided. The mobile device comprises a unit to acquire raw data; a storage unit to store the raw data and blog information; and a blog editor to generate/edit a blog page based on the raw data and the blog information.

According to another aspect of the present invention, a method of providing a blog service using a mobile device is provided. The method comprises acquiring raw data needed to generate a blog; generating the blog based on the raw data; storing the blog; and transmitting the stored blog from the mobile device to other devices so as to share the blog with the other devices.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an example of layouts of a blog page provided by a blog service provider according to a conventional technique;

FIG. 2 illustrates a structure of a blog service system using a mobile device according to an embodiment of the present invention;

FIG. 3 is a functional block diagram illustrating a hardware structure of a mobile device to generate and share a blog according to an embodiment of the present invention;

FIG. 4 is a flowchart of a process of providing a blog service according to an embodiment of the present invention, in detail;

FIG. 5 illustrates an example of a layout of a blog page generated according to an embodiment of the present invention; and

FIG. 6 illustrates an example of a product to which a blog service system using a mobile device according to an embodiment of the present invention can be applied.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

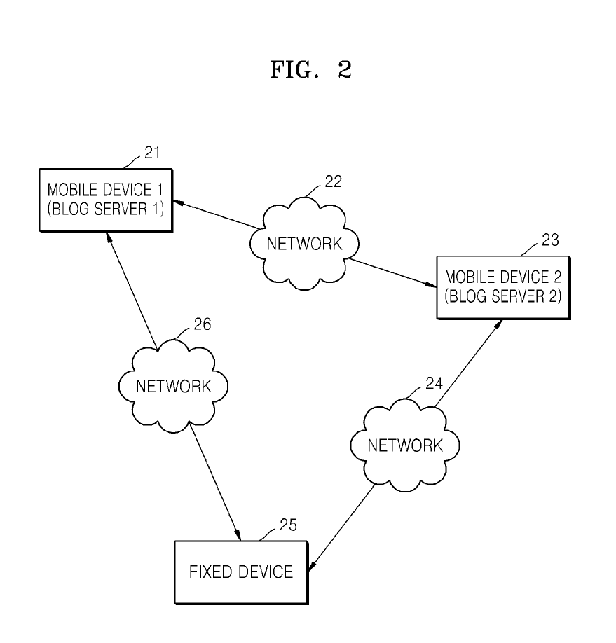

FIG. 2 shows a structure of a blog service system using a mobile device according to an embodiment of the present invention. The system includes one or more mobile devices 21 and 23 and one or more fixed devices 25. The one or more mobile devices and the one or more fixed devices are connected to one another through a wired and/or wireless network 22, 24, and 26, such as a Wi-Fi, Bluetooth, or Ethernet network.

If a mobile device operates as a blog server, the other devices operate as clients with respect to the mobile device. For example, if a first mobile device 21 operates as a blog server, a second mobile device 23 and the fixed device 25 operate as clients with respect to the first mobile device 21. In addition, the second mobile device 23 can also operate as a blog server. In this case, the first mobile device 21 and the fixed device 25 operate as clients.

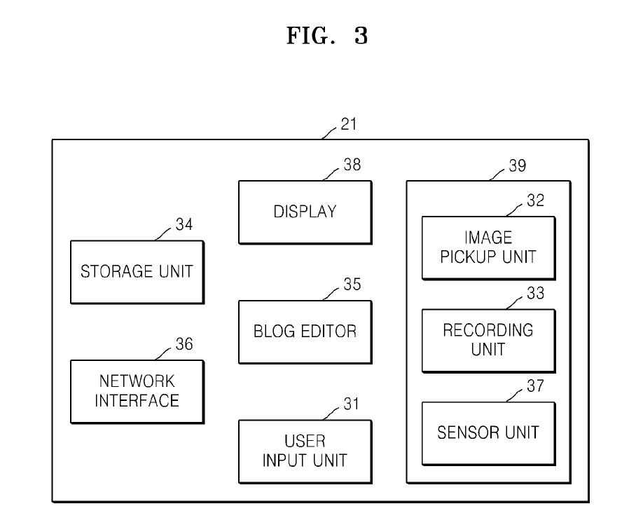

FIG. 3 shows a mobile device 21 to generate and share a blog according to an embodiment of the present invention. The mobile device 21 includes a user input unit 31, a raw data acquisition unit 39, a storage unit 34, a blog editor 35, a network interface 36, and a display 38. According to other aspects of the present invention, the mobile device 21 may include additional and/or different units. Similarly, the functionality of two or more of the above units may be integrated into a single component.

The raw data acquisition unit 39 includes an image pickup unit 32, a recording unit 33, and a sensor unit 37 so as to acquire raw data such as images, voices, and the like to generate a blog (or blog page). Other units may also be employed to acquire raw data in addition to, or instead of, the above-listed units. The image pickup unit 32 serves to take a still image and a moving image and to record voice or music. The sensor unit 37 may include one or more sensors, such as a global positioning system (GPS), an acceleration measurement sensor, a pulse measurement sensor, a temperature sensor, and the like. The GPS serves to gather position information using satellites. The acceleration measurement sensor, the pulse measurement sensor, and the temperature sensor respectively serve to measure a travel distance/velocity of the mobile device, a pulse of a user, and a temperature of the user. These values may be used for life logging.

The storage unit 34 stores raw data acquired by the raw data acquisition unit. The storage unit 34 may store generated/edited blog data, blog information (for example, information on a blog layout, encoding information, and database information), information on service policies, and the like, in addition to the raw data. In addition, the storage unit 34 may include a blog program needed for sharing the blog data.

The blog editor 35 serves to generate/edit a blog page using the raw data and the blog information based on a control signal received by the user input unit 31. The user can generate/edit a blog by using the blog editor in the mobile device without accessing the server of the blog service provider.

The user can input text so as to construct a blog (or a blog page) through the user input unit 31 or input a control command for generating/editing the blog. The display 38 including a liquid crystal display (LCD) serves to visually display the blog page generated/edited using the blog editor.

The network interface 36 transmits the generated/edited blog page data to an external device, so that the blog service mobile device 21 and 23 operates as a server. The network interface can employ a peer-to-peer (P2P) protocol or a world wide web (WWW) protocol as a transmission protocol. In addition, the network interface 36 may be used as a unit to access a public area network (PAN). In addition, the mobile device 21 may further include a service policy manager (not shown). The service policy manager serves to control access to the blog.

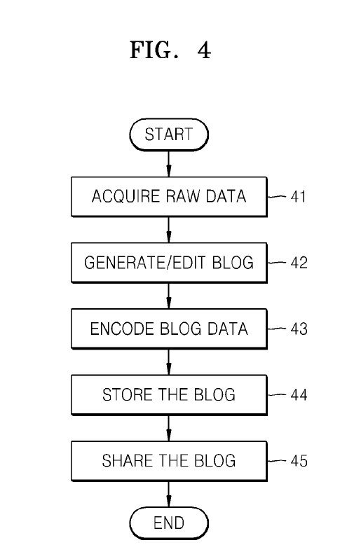

FIG. 4 is a flowchart of a process of providing a blog service according to an embodiment of the present invention. In order to prepare a blog page, raw data to construct the blog page is acquired in operation 41. Image data may be acquired by the image pickup unit 32. Audio data is acquired by the recording unit 33. Text data may be acquired by the user input unit 31. Image/audio/text data received from a PAN (stored in the storage unit) may be used to generate the blog page.

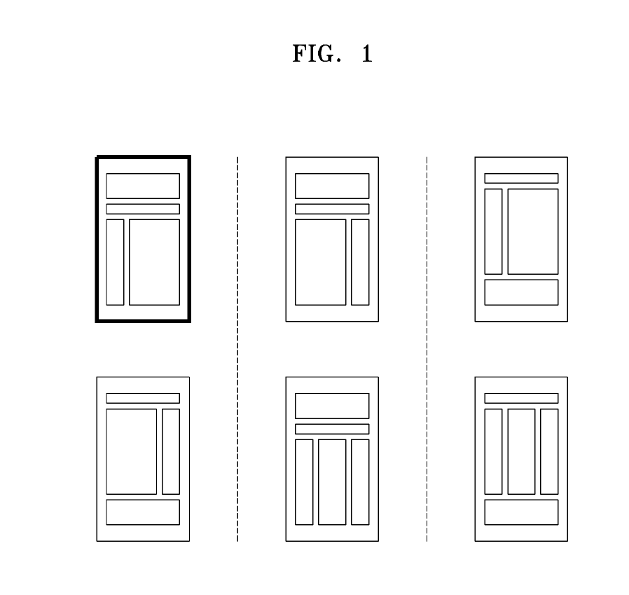

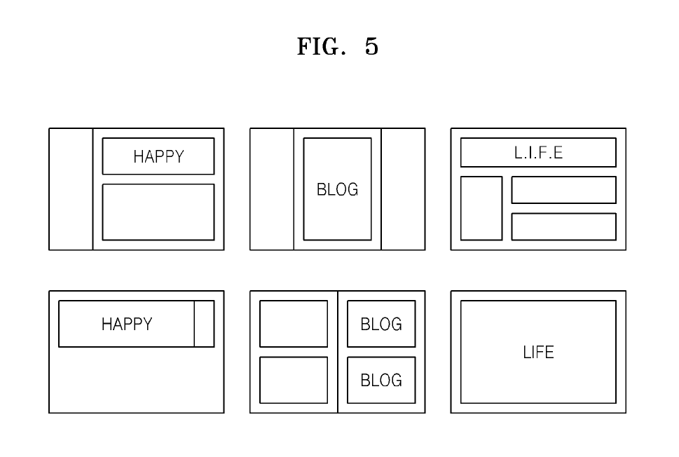

In operation 42, the user designs a layout of the blog page. The user can construct the layout of the blog page in various forms desired by the user. Examples of the layout of the blog page are shown in FIG. 5. Layouts of the blog page according to the embodiment are more various than layouts of a blog page shown in FIG. 1. Next, the blog page is completed by inserting the image/audio data generated in operation 41 and inserting necessary text through the user input unit into the blog page. In addition, the user can freely select types of video players to be used for the blog and insert a banner advertisement into the blog page.

In operation 43, blog data is encoded. The generated blog page data should be stored so as to be shared with other devices (or users). The generated blog page data should be encoded in a suitable file format, before being stored. For example, the blog data should be encoded in a file format that is generally and widely used, so that the generated blog is freely shared by other devices without dedicated programs. For example, an MPEG4 format, an H.264 format, an audio video interleave (AVI) format, and the like, which are widely used, are employed as a file format of stored video data. However, other file formats may also be employed. The encoded blog data is stored in the storage unit 34 in operation 44.

In operation 45, the generated/stored blog data is shared. The generated/stored blog data is provided to users of other devices through a network. First, the devices request the blog data stored in the storage unit of the mobile device after accessing the mobile device through the network interface by using the P2P or WWW protocol. The mobile device providing a blog thus operates as a blog server or web server. Accordingly, it is desirable to manage blog data stored in the storage unit as a database. It is easy to generate, modify, delete, and search for the blog data that is managed as the database.

The mobile device includes a blog program and a service policy manager so as to operate as a blog server. The service policy manager may limit other users who desire to access a blog. The service policy manager may also serve to partially limit opening of the blog data.

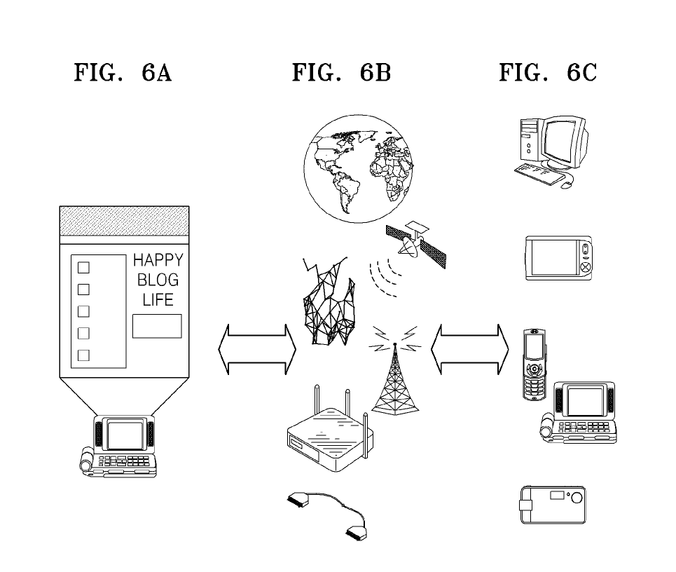

FIG. 6 shows an example of a product to which a blog service system using a mobile device according to an embodiment of the present invention can be applied. FIG. 6A shows the mobile device 21 or 23 including blog data. The mobile device may be a mobile phone, a digital camera, a portable digital assistant (PDA), or a notebook computer.

FIG. 6C shows an example of other devices for sharing the blog provided by the mobile device. The devices may be a desktop computer, a PDA, a mobile phone, a digital camera, and the like. FIG. 6B shows an example of a communication network for electrically connecting the mobile device to the devices. The communication network may be various cables and various wired/wireless networks.

If the method and apparatus for providing a blog service according to aspects of the present invention, is used, there are several advantages. First, while in the past, a user has to access a blog web server of a service provider through the Internet so as to use the blog service, according to aspects of the present invention, the user can freely use the blog service at any time at any place without an access to the blog web server. Second, the user can freely construct a blog desired by the user without being limited by predetermined layouts and without a limit of storage capacity. Third, while in the past, a blog page uploaded to the blog server is opened to the public, according to aspects of the present invention, opening of the blog page may be limited so as to protect privacy of the user with respect to the blog page.

Aspects of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CDs, DVDs, magnetic tapes, floppy disks, and optical data storage devices. Aspects of the present invention may also be embodied as carrier waves (such as data transmission through the Internet). The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A mobile device that operates as a blog providing server, the mobile device comprising:
a unit to acquire raw data;
a storage unit to store the raw data and blog information; and
a blog editor to generate/edit a blog page based on the raw data and the blog information.

2. The mobile device of claim 1, wherein a layout of the blog page is determined by a user.

3. The mobile device of claim 1, further comprising a network interface to transmit blog data to an external device.

4. The mobile device of claim 3, wherein the network interface employs a P2P protocol or a WWW protocol as a transmission protocol.

5. The mobile device of claim 1, wherein the unit to acquire the raw data includes one or more of an image pickup unit, a recording unit, and a sensor unit.

6. The mobile device of claim 5, wherein the sensor unit includes one or more among a GPS, an acceleration measurement sensor, a pulse measurement sensor, and a temperature sensor.

7. The mobile device of claim 1, further comprising a user input unit to input a control command to generate/edit the blog.

8. The mobile device of claim 1, further comprising a service policy manager to limit another user who accesses the blog.

9. The mobile device of claim 1, further comprising a display to display the generated blog.

10. The mobile device of claim 1, wherein the mobile device is a mobile phone, a digital camera, a PDA, or a notebook computer.

11. The mobile device of claim 1, wherein:
the mobile device of claim 1 is a component of a blog service system including one or more fixed devices and one or more mobile devices; and
the mobile device of claim 1 shares a blog generated by one of the mobile devices with other devices in the system.

12. A method of providing a blog service using a mobile device, the method comprising:
acquiring raw data needed to generate a blog;
generating the blog based on the raw data;
storing the blog; and
transmitting the stored blog from the mobile device to other devices so as to share the stored blog with the other devices.

13. The method of claim 12, further comprising encoding the acquired raw data in a predetermined file format.

14. The method of claim 13, wherein the predetermined file format is one of an MPEG4 format, an H.264 format, and an AVI format.

15. The method of claim 12, wherein the generating of the blog includes determining a layout of a blog page.

16. The method of claim 15, wherein the layout format of the page is determined by a user.

17. The method of claim 12, wherein the sharing of the stored blog includes:
connecting the mobile device to an external device; and
transmitting data on the stored blog to the external device.

18. The method of claim 12, wherein the sharing of the blog includes managing service policies to limit another user who desires to access the blog.

19. The method of claim 12, wherein the raw data includes one or more of image data, audio data, and text data.

20. The method of claim 12, wherein the transmitting of the blog entry comprises transmitting the blog entry from the mobile device to other devices so as to share the blog every with the other devices without requiring the other devices to access a blog web server.

21. The mobile device of claim 1, wherein the external device is not a blog web server.
